(19) United States
(12) Patent Application Publication
(10) Pub. No.: US 2004/0125093 A1
(43) Pub. Date: Jul. 1, 2004

(54) Micro-controller with integrated light modulator

(76) Inventors: Serge Rutman, Boulder Creek, CA (US); Oleg Rashkovskiy, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/335,005

(22) Filed: Dec. 30, 2002

(51) Int. Cl. G09G 5/00

(52) U.S. Cl. 345/204

(57) ABSTRACT

A single chip light processing system includes an on-chip light modulator on the chip and an on-chip processor on the chip. In some examples, at least a portion of the on-chip processor is formed on a different physical layer of the chip with respect to the on-chip light modulator. In some examples, an area of the on-chip processor overlaps with an area of the on-chip light modulation structure.

### FIELD OF THE INVENTION

The invention relates to integrated circuits, and more particularly to integrated circuits including a light modulator.

### BACKGROUND AND RELATED ART

Light modulator structures are well known in the art. Such structures includes liquid crystal displays (LCDs), light emitting diodes (LEDs), and micro-electronic mirror systems (MEMS). LCDs may be reflective or transmissive. Crystalline silicon may be used to manufacture liquid crystal on silicon (LCOS) displays.

With reference to FIG. 1, a conventional display system 10 includes an integrated circuit 12 which includes a pixel structure 14 and a memory circuit 16 on the same integrated circuit 12. The memory circuit 16 is disposed on an area of the integrated circuit 12 outside of the area of the pixel structure 14. The integrated circuit 12 is connected to a display micro-controller 18 which is not on the same substrate of the integrated circuit 12.

U.S. Pat. No. 6,326,958 discloses a miniature display system which is formed on three distinct substrates with different features sizes and operating in different power zones. The display controller and other high speed logic are formed on one substrate. The display, digital to analog converters (DACs) and look-up tables (LUTs) are formed on a second substrate. High voltage circuitry for driving LEDs and the cover glass voltage is formed on a third substrate.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a block diagram of a conventional display system.

FIG. 2 is a block diagram of an integrated circuit including a light modulator according to some embodiments of the invention.

FIG. 3 is a perspective view of an integrated circuit including a light modulator according to some embodiments of the invention.

FIG. 4 is a block diagram of an integrated circuit including a light modulator according to some embodiments of the invention.

FIG. 5 is a schematic diagram of an integrated circuit including a light modulator according to some embodiments of the invention.

FIG. 6 is a block diagram of an integrated circuit including a light modulator according to some embodiments of the invention.

FIG. 7 is a schematic diagram of a computer system utilizing an integrated circuit including a light modulator according to some embodiments of the invention.

FIG. 8 is a schematic diagram of a computer system utilizing an integrated circuit including a light modulator according to some embodiments of the invention.

FIG. 9 is a schematic diagram of a computer system utilizing an integrated circuit including a light modulator according to some embodiments of the invention.

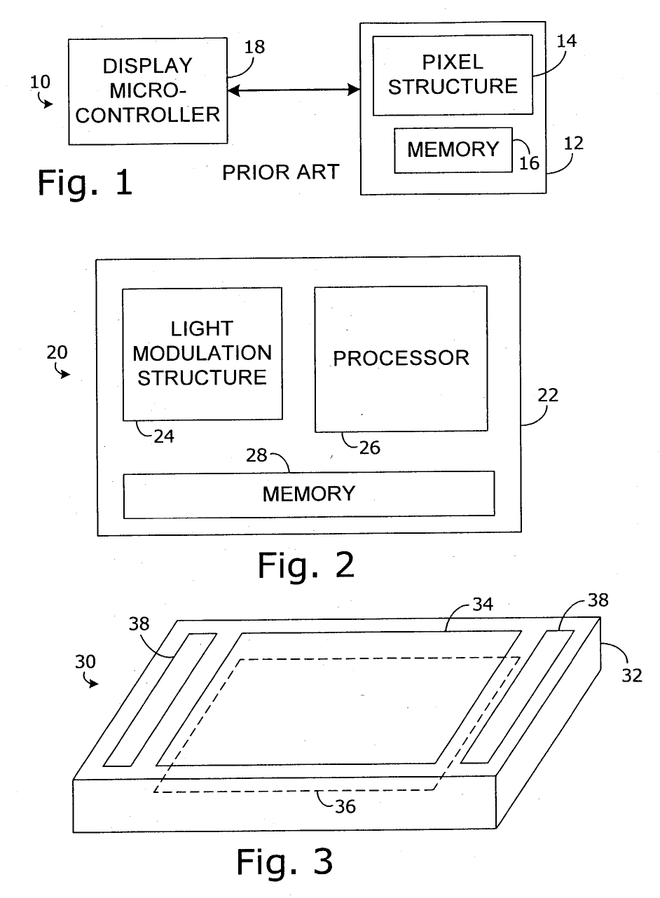

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

The size of the pixel structure in display systems is generally limited to a minimum resolution determined by the projection optics (e.g. 12×8 micron typical pixel size). However, the advance of various silicon manufacturing processes (e.g. the CMOS process) allows more circuitry in a fixed area (i.e. higher circuit density). Accordingly, the area occupied by associated pixel drive electronics become smaller while the size of the pixel structure is more or less the same.

According to some embodiments of the invention, processor circuits (e.g. a display microcontroller) may be integrated on the same substrate as the light modulation structure (e.g. the pixels). With reference to FIG. 2, some examples of the invention include a light processing system 20 having an integrated circuit 22 which includes a light modulation structure 24 and a processor 26 on the same integrated circuit 22. For example, the light processing system 20 may comprise a display system, in which case the light modulation structure is a pixel structure and the processor is a display micro-controller. Alternatively, the light processing system may comprise an optical communication system, in which case the light modulation structure is part of an optical bus and the processor may be a general purpose processor or an input/output (i/o) processor. The system 20 may further include a memory circuit 28 or other circuitry on the same integrated circuit 22. Other components of example systems (e.g. such as a light engine, optics, and a picture source) are not shown.

Many projection display architectures utilize a single light modulation chip to process more than one color component. This arrangement generally requires the light modulation device to carry on-chip memory. In conventional display systems, the on-chip memory in the light modulation device essentially replicates the on-chip memory in the separate display microcontroller. An advantage of the present invention is that with the display controller integrated on the same substrate as the pixel structure, the duplicate memory is not needed. Alternatively, if the optional on-chip memory circuit is present, the on-chip memory may be utilized for other display functions including without limitation buffering, image formatting, and other processing operations.

According to some embodiments of the invention, the area underneath a light modulation structure is utilized to provide circuits for processing. With reference to FIG. 3, some examples of the invention include a light processing system 30 having an integrated circuit 32 which includes a light modulation structure 34 and additional circuitry 36. At least a portion of the additional circuitry 36 is built in the area underneath the light modulation structure 34 on the same substrate of the integrated circuit 32. An area of the light modulation structure 34 overlaps with an area of the additional circuitry 36, but on different physical layers. In some examples, the additional circuitry 36 comprises a processor circuit (e.g. a display micro-controller). The system 30 optionally includes additional on-chip memory 38 or other circuitry which may be utilized for synchronized image formatting, processing and buffering operations. The on-chip memory 38 may be built on the same physical layer as the light modulation structure 34. Alternatively, all or a portion of the memory 38 may be built in the area underneath the light modulation structure 34. An advantage of utilizing the area underneath the light modulation structure 34 for additional circuitry 36 is that the overall size of the integrated circuit 32 is reduced, thereby decreasing cost and increasing yield.

Some examples of the invention provide an advantage by including more functionality in the light modulation device without substantially increasing the cost of the device (e.g. because the die size does not substantially increase). For example, functionality may be increased by utilizing the on-chip memory for multiple color components. Further integration facilitates further on-chip functionality including:

1) Synchronized image formatting;

2) Processing operations; and/or

3) Buffering operations.

In conventional display systems, image formatting is generally done by a separate display controller which has a substantial amount of memory and control circuitry. Integrating various portions of the display controller circuits onto a single chip light modulator provides advantageous cost savings. Moreover, further advantages may be obtained in some embodiments of the invention which are difficult to provide in separate chips. For example, performing decoding and decompression in the single chip imager of the present invention may provide better copy protection because the data remains encoded and/or compressed until just prior to use of the data and there are no external pins or signal lines from which the data may be intercepted. There are also some potential bandwidth savings due to the fact that the data stays compressed until the end of the pipeline.

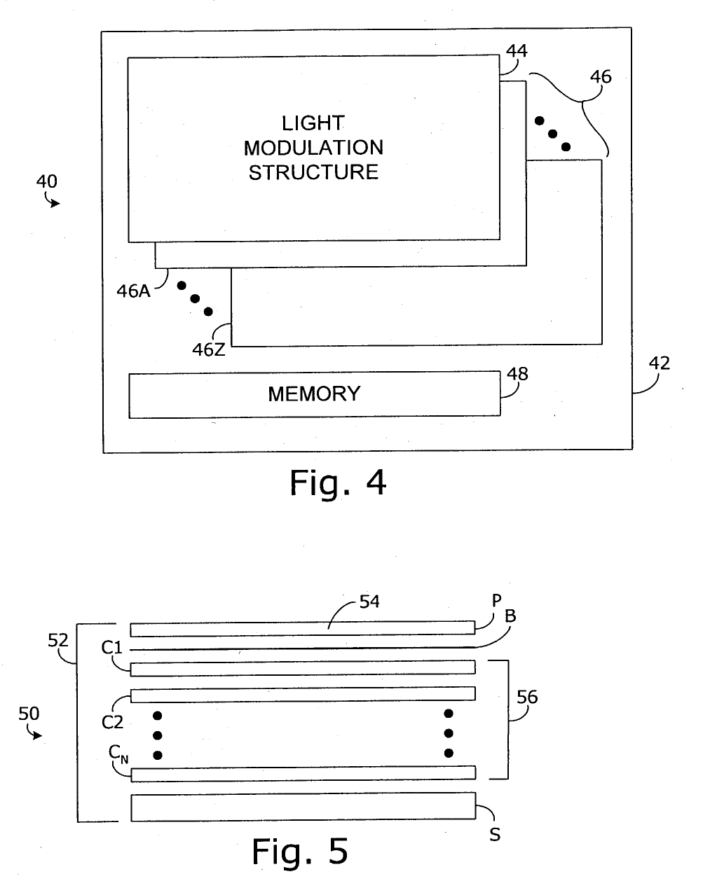

With reference to FIG. 4, other examples of the invention includes a light processing system 40 having an integrated circuit 42 which includes a light modulation structure 44 and additional circuitry 46 which is positioned beneath the light modulation structure 44. For example, the additional circuitry 46 includes a processor circuit. The additional circuitry 46 may be built from two or more physical layers 46A through 46Z. The system 40 optionally includes additional on-chip memory 48 or other circuits.

As is well known in the art, integrated circuits may be constructed utilizing a plurality of layers of conductive, semi-conductive and/or insulating materials, with connections made between layers (e.g. with vias). With reference to FIG. 5, some examples of the invention include a light processing system 50 having an integrated circuit 52 which includes a substrate S. The integrated circuit 52 includes a light modulation structure 54 on a physical layer P, which is generally an outermost layer of the integrated circuit 52. The integrated circuit 52 further includes additional circuitry 56 (e.g. a processor circuit) on at least one physical layer C1 positioned between the physical layer P and the substrate S. The additional circuitry 56 may include two or more physical layers C1, C2, through C_{N} positioned between the physical layer P and the substrate S. If necessary or desirable, the integrated circuit 52 may include a physical buffer layer B between the physical layer P and the physical layers C1 . . C_{N} of the additional circuitry 56. The integrated circuit 52 may include additional on-chip memory or other circuits on any of the physical layers (e.g. including layers P and C1 . . C_{N}), including circuits in the area outside the area of the light modulation structure 54. Advantageously, by utilizing the area underneath the light modulation structure 54 for additional circuitry 56 the overall size of the integrated circuit 52 is reduced, thereby decreasing cost and increasing yield.

The light modulation structure generally utilizes either a reflective structure (e.g. mirror-like materials such as silver and/or aluminum) or a light generating structure (e.g. such as an LED), or a combination thereof. For display systems, the light modulation structure are generally arranged in an array of pixels. For example, each pixel may be an electrode with a stack on top which improves or otherwise affects the reflective properties of the structure. Known pixel structures which may be made from silicon include various LCOS and MEMS structures.

The additional circuitry between the light modulation structure and the substrate generally includes silicon micro-electronics circuitry, e.g. metal and/or insulators layered and connected through layers with vias. Specific implementation of any particular additional circuitry largely depends on the light modulation scheme implemented in the imager. For example in digital LCOS imagers the additional circuitry may include on-chip memory cells and drive circuitry associated with each pixel. Each memory cell may include a D-flip/flop to hold the current state of a PWM waveform for the pixel and a buffer to translate from logic level voltages to V_{LC}, a voltage level compatible with the LC material. The specific value of V_{LC} depends on the LC material. The voltage translation buffer is configured to drive the LC stack for the pixel through the pixel electrode. The ITO bias voltage, V_{ITO} externally applies the proper bias to the LC cell to preserve DC balance.

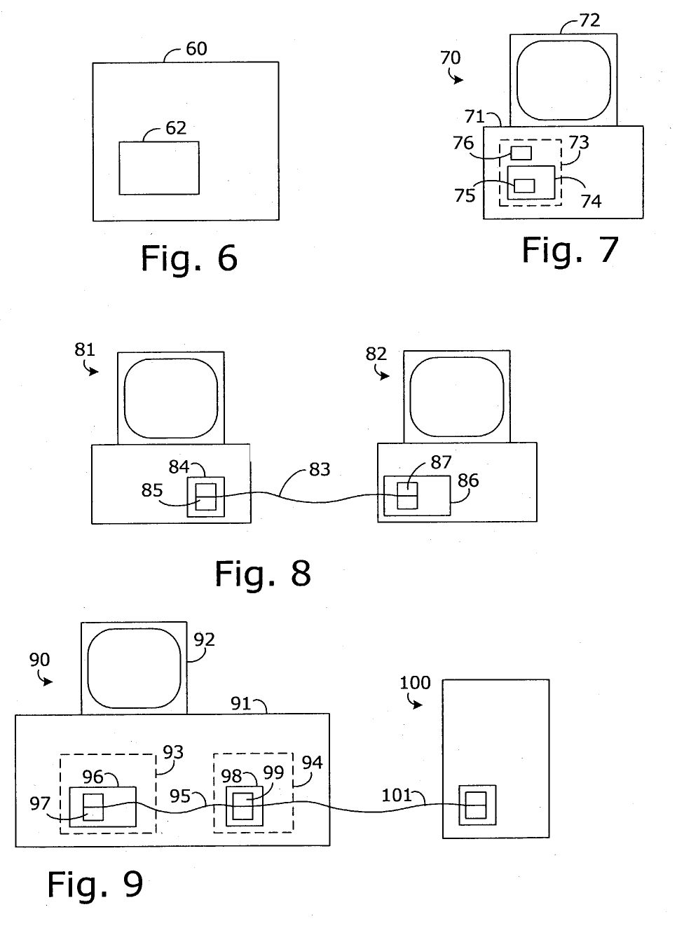

With reference to FIG. 6, according to some examples of the invention an integrated circuit 60 includes a general purpose processor and a light modulation structure 62 integrated on the same substrate. For example, the integrated circuit 60 may have any of the structures described above in connection with FIGS. 2-5. The general purpose processor may comprise, for example, an Intel® Pentium 4® or Itanium® processor, or other general purpose processor. For example, the integrated circuit 60 may be utilized in a sophisticated display system including a computer system with a projection display or a high definition projection television system that also provides access to the internet or other computer applications. Integrating the processor and display device on a single chip may significantly reduce the cost of such systems.

A single chip light processing system utilizing the integrated circuit 60 includes the on-chip light modulator 62 on the chip and an on-chip processor on the same chip. In some examples, at least a portion of the on-chip processor is formed on a different physical layer of the chip with respect to the on-chip light modulator. An area of the on-chip processor may overlap with an area of the on-chip light modulation structure. The chip may further include a buffer layer disposed between the on-chip light modulator and the on-chip processor. Some examples also include an on-chip memory. In some examples, the on-chip processor is advantageously adapted to perform on-chip buffering with the on-chip memory (e.g. frame buffering). In some examples, the processor is advantageously adapted to manage multiple color components with the on-chip memory. In some examples, the processor is advantageously adapted to perform synchronized image formatting. The processor may b adapted to provide to or more of the foregoing integrated functionalities, as well as other processing operations. In some examples, the on-chip light modulator is utilized to drive a display. In some examples, the on-chip light modulator is utilized to transfer data.

With reference to FIG. 7, a computer system 70 includes an enclosure 71 (e.g. a desktop or laptop housing) and a separate display 72. An integrated light transceiver 73 including an integrated circuit 74 is disposed inside the enclosure 71. For example, a light modulation structure 75 is integrated on the integrated circuit 74 as described above. In some examples, the integrated circuit 74 includes additional circuitry (e.g. a general purpose processor), at least a portion of which may be positioned underneath the light modulation structure 75. A light receiving structure 76 is also disposed inside the enclosure 71. The light receiving structure 76 is adapted to receive light signals and convert the light signals to digital signals. In some examples, the light receiving structure 76 is also integrated on the same substrate as the integrated circuit 74. For example, the light receiving structure 76 comprises photodiodes and/or charge coupled devices (e.g. such as the devices found in digital cameras). With the integrated light transceiver 73, the system 70 can exchange data optically with other electronic devices. Advantageously, high resolution modulation and receiving structures may include thousands or millions of pixels for potentially massively parallel data transfer. For example, LCOS and MEMS devices provide display resolutions of 800×1024 or more pixels and digital image capture devices provide resolutions in excess of 5 million pixels, each pixel of which can be further encoded with color information. Alternatively, where LEDs are utilized for the light modulation structure and photodiodes are utilized for the receiving structure, high speed serial and/or parallel data transfer may be accomplished. For example, parallel data transfer may be accomplished with a plurality of LEDs and/or a plurality of color encoded channels.

With reference to FIG. 8, a first electronic system 81 is adapted to transfer data to a second electronic system 82 over an optical link 83. The first system 81 includes a first integrated light transceiver 84 including a first integrated circuit 85. For example, at least one of a light modulator and a light receiver are integrated on the integrated circuit 85 together with a processor circuit. The second system 82 includes a second integrated light transceiver 86 including a second integrated circuit 87. The first light transceiver 84 is optically coupled to the second light transceiver 86. Appropriate optical elements (e.g. light sources, lenses, collectors, filters, light guides, splitters, amplifiers, repeaters, etc.) are utilized to transmit light signals from the first transceiver 84 to the second transceiver 86. For example, the first transceiver 84 is connected to the second transceiver 86 by a fiber optic cable.

With reference to FIG. 9, some examples of the invention utilize an integrated light transceiver to support an internal optical bus. An electronic system 90 includes an enclosure 91 and a display 92. Inside the enclosure 91, a first electronic device 93 is adapted to transfer data to a second electronic device 94 over an optical link 95. The first device 93 includes a first integrated light transceiver 96 including a first integrated circuit 97. For example, at least one of a light modulator and a light receiver are integrated on the integrated circuit 97 together with a processor circuit. The second device 94 includes a second integrated light transceiver 98 including a second integrated circuit 99. For example, the second device 94 comprises main memory for the electronic system 90 such that the processor for the system 90 is optically coupled to the main memory of the system 90 over the optical link 95 (e.g. a fiber optic cable). The system 90 may be further coupled to a second system 100 over an optical link 101.

The foregoing and other aspects of the invention are achieved individually and in combination. The invention should not be construed as requiring two or more of the such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. An integrated circuit, comprising:
a substrate;
a light modulation structure formed on the substrate; and
a processor circuit formed on the same substrate with the light modulation structure.

2. The integrated circuit as recited in claim 1, wherein at least a portion of the processor circuit is formed on a physical layer disposed between the light modulation structure and the substrate.

3. The integrated circuit as recited in claim 2, wherein the light modulation structure occupies an area over the substrate and wherein at least a portion of the processor circuit is positioned on the physical layer in an area which overlaps with the area of the light modulation structure.

4. The integrated circuit as recited in claim 3, further comprising a buffer layer disposed between the light modulation structure and the physical layer of the processor circuit.

5. The integrated circuit as recited in claim 1, wherein at least a portion of the processor circuit is formed on a plurality of physical layers disposed between the light modulation structure and the substrate.

6. The integrated circuit as recited in claim 1, further comprising an additional circuit formed on the same substrate as the light modulation structure.

7. The integrated circuit as recited in claim 6, wherein the additional circuit comprises a memory circuit.

8. The integrated circuit as recited in claim 1, wherein the light modulation structure comprises at least one of a light emitting diode, a liquid crystal structure, and a micro-electronic mirror structure.

9. A single chip light processing system, comprising:
an on-chip light modulator on the chip; and
an on-chip processor on the chip.

10. The system as recited in claim 9, wherein at least a portion of the on-chip processor is formed on a different physical layer of the chip with respect to the on-chip light modulator.

11. The system as recited in claim 10, wherein an area of the on-chip processor overlaps with an area of the on-chip light modulation structure.

12. The system as recited in claim 11, further comprising a buffer layer disposed between the on-chip light modulator and the on-chip processor.

13. The system as recited in claim 9, further comprising:
an on-chip memory.

14. The system as recited in claim 13, wherein the on-chip processor is adapted to perform on-chip buffering with the on-chip memory.

15. The system as recited in claim 13, wherein the processor is adapted to manage multiple color components with the on-chip memory.

16. The system as recited in claim 13, wherein the processor is adapted to perform synchronized image formatting.

17. The system as recited in claim 9, wherein the on-chip light modulator is utilized to drive a display.

18. The system as recited in claim 9, wherein the on-chip light modulator is utilized to transfer data.

19. An electronic system, comprising:
an enclosure; and
an integrated light transceiver disposed within the enclosure, wherein the integrated light transceiver includes at least a light modulator and a processor integrated on a single integrated circuit.

20. The system as recited in claim 19, wherein the integrated light transceiver further includes a light receiver.

21. The system as recited in claim 20, wherein the light receiver is integrated on the integrated circuit with the light modulator and processor.

22. The system as recited in claim 20, wherein the integrated light transceiver is adapted to transfer data to another electronic system over an optical link.

23. The system as recited in claim 20, wherein the integrated light transceiver is adapted to transfer data to another electronic device inside the enclosure over an optical link.

24. The system as recited in claim 19, wherein an area of the processor on the integrated circuit overlaps with an area of the light modulator.
